(19) United States
(12) Patent Application Publication
(10) Pub. No.: US 2006/0227821 A1
(43) Pub. Date: Oct. 12, 2006

(54) Tunable laser

(75) Inventor: Alex Klooster, Ann Arbor, MI (US)

Correspondence Address: SCHOX PLC, 209 N. MAIN STREET #200, ANN ARBOR, MI, 48104, US

(73) Assignee: Coherix, Inc., Ann Arbor, MI (US)

(21) Appl. No.: 11/093,419

(22) Filed: Mar. 30, 2005

(51) Int. Cl. H01S 3/10

(52) U.S. Cl. 372/20

(57) ABSTRACT

A tunable extended cavity laser is disclosed having a single flexure pivot or hinge forming a pivot axis about which a grating tuning element is rotated. The pivot axis does not move appreciably as the grating is pivoted. The most preferred embodiment of the flexure hinge is a cartwheel hinge.

### FIELD OF THE INVENTION

The field of the invention is the field of tunable lasers.

### BACKGROUND OF THE INVENTION

The basic principles of the operation of the tunable laser utilizing a variable length external cavity in conjunction with a diffraction grating and a rotatable mirror are set forth in the publication, “Spectrally Narrow Pulse Dye Laser Without Beam Expander,” by Michael G. Littman and Harold J. Metcalf, Applied Optics, vol. 17, No. 14, pages 2224-2227, Jul. 15, 1978. Although the article describes a system which uses a dye laser, the diode laser is easily substituted. The system utilizes a diffraction grating which is filled with an incident collimated laser beam by using the grating at a grazing angle. The diffracted beam at the angle normal to the mirror is reflected back onto the grating and from there it is diffracted in a direction opposite the original collimated beam. The first order of diffraction of the grating is incident on the mirror, which reflects it back onto the grating, where the first order of diffraction passes back into the gain medium, where it serves to determine the operating wavelength of the laser. The output of the system is the zero-order reflection from the grating at grazing incidence. Motion of the mirror with respect to the grating allows the system to be tuned to a desired output wavelength.

The above mentioned design is susceptible to discontinuities in the output spectrum. These discontinuities are caused by mode hopping which is a change in the integral number of wavelengths in the cavity over the tuning range. To overcome mode hopping U.S. Pat. No. 5,319,668 teaches a pivot point for the reflective element, e.g. mirror or dihedral reflector, which provides for simultaneous rotary and linear motion with respect to the grating and thus theoretically overcomes the problem of mode hopping. The pivot point is selected so as to provide an internal cavity length which is exactly an integral number of half wavelengths at three different wavelengths and an exceptionally close (within 1/1000 of one wavelength) match at all other wavelengths within the tuning range. The pivot point calculation takes into account the effect of the dispersion of the gain medium and other optical elements in the system on the cavity length.

U.S. Pat. No. 5,885,521 avoids the expense of precision bearings needed for pivoting the reflective element about the pivot point. Two torsion hinges are disclosed which together form a pivot axis about which the grating can be rotated. As the grating is rotated, the pivot axis does not move enough to disturb the cavity length required for smooth, mode hop free tuning, Such a pair of torsion hinges is needed to provide stability of the axis in the micron range.

U.S. Pat. No. 6,690,690 discloses a tunable laser system having an adjustable external cavity which provides a flat plate flexural element or hinge to allow rotation of the grating mounted in a Littrow configuration, instead of the Littman configuration of the prior art devices above. However, the pivot axis about which the grating pivots moves as the flexural element flexes. U.S. Pat. No. 6,690,690 also shows a reflecting mirror fixedly rotating with the tuning grating in the long known method for ensuring that an output beam reflected from the rotating tuning grating (diffraction order zero) remains parallel to itself as the grating is tuned. (See, for example U.S. Pat. No. 3,790,898). The output beam, however, moves perpendicular to itself as the grating is tuned.

### RELATED PATENTS AND APPLICATIONS

This patent application is related to one other application filed by the same inventor on the same day.

### OBJECTS OF THE INVENTION

It is an object of the invention to produce a tunable laser apparatus, system, and method which is stable and inexpensive, and which provides a broad tuning range with few or with closely controlled mode hops.

### SUMMARY OF THE INVENTION

A base for mounting a laser amplifier and high reflectivity back reflector for a laser cavity is connected with a single flexural element to a mounting arm for mounting a laser feedback tuning element, thus providing a pivot axis about which the mounting arm pivots, and wherein the pivot axis does not move appreciably as the pivot arm rotates to tune the laser output.

A reflective element working in conjunction with a plane grating to tune a tunable laser, wherein the laser output beam does not move as the tunable laser is tuned.

### BRIEF DESCRIPTION OF THE DRAWINGS

FIG. 1 shows a tunable laser.

FIG. 2 shows a tunable laser.

FIG. 3 shows beam positions as the grating of FIG. 2 is rotated.

FIG. 4 shows a tunable laser.

FIG. 5 shows an embodiment of the invention.

FIG. 6 shows beam positions as the grating of FIG. 5 is rotated.

FIG. 7 shows a plan view of a cartwheel hinge flexure element.

FIG. 8 shows a plan view of the cartwheel hinge flexed.

FIG. 9 shows a sketch of the most preferred embodiment of the invention.

### DETAILED DESCRIPTION OF THE INVENTION

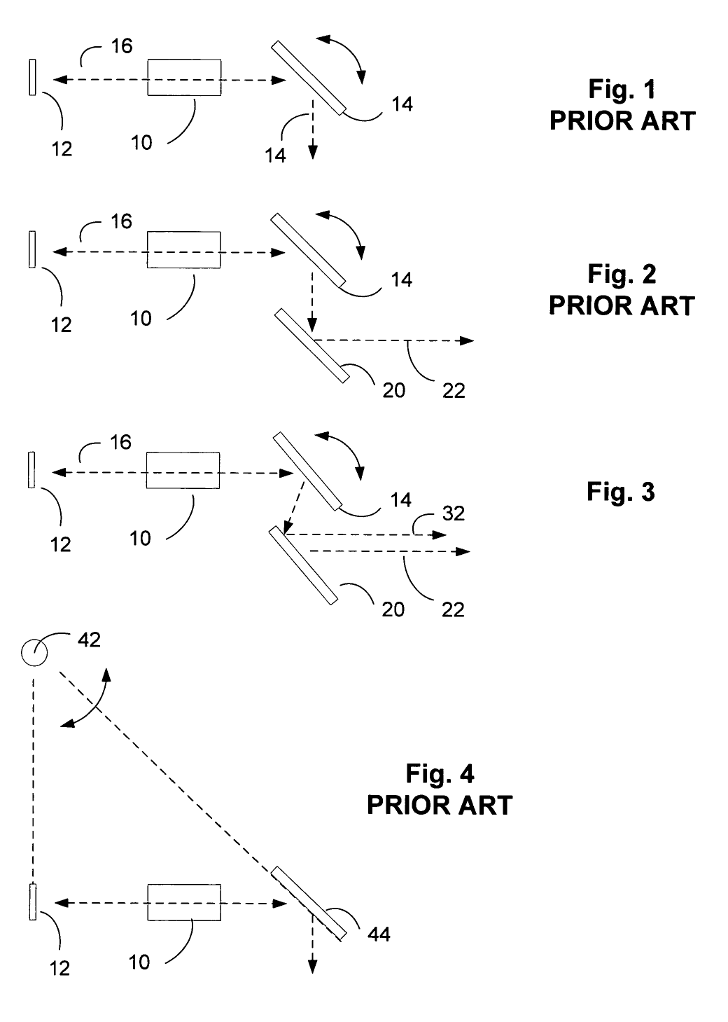

FIG. 1 depicts a tunable laser cavity set up with a laser amplification module 10, a rear reflector 12, and a tuning module 14. Light 16 is reflected back and forth between reflector 12 and module 14, and is amplified by module 10. Amplification module 10 may contain a gas, liquid, or solid medium as active medium. Fluorescent dyes in solution and semiconductor devices are among the most popular media for amplification because they exhibit rather large gain bandwidths, but doped optical fibers and Raman effect amplifiers, and Raman active fluid filled fibers are also anticipated by the inventor. Tuning module 14 is represented in FIG. 1 as a grating set up to diffract a non-zero grating order back to the amplification module. The grating is rotatable about an axis so that different wavelengths of light may be fed back and amplified to produce laser light. The laser output beam 18 is shown in FIG. 1 as the reflected zero order diffracted beam from the grating. Other well known in the art tuning modules may be used to reflect the desired wavelength for amplification.

FIG. 2 shows a set up known in the art where the output beam 18 for the laser, which would not remain parallel to itself as the tuning module was tuned, is further reflected by a reflection module 20 to produce an output beam 22 which does remain parallel as the grating 14 is rotated. The grating 14 and the reflection module 20 are rotated by the same amount, a task which is easily accomplished by fixing the grating and amplification module 20 together.

Note that, while the beam 32 remains parallel to the original beam 22, it moves perpendicular to itself as is shown in FIG. 3 for a rotated grating 14 and affixed reflector 20.

FIG. 4 shows a prior art set up to ensure that the number of half wavelengths in the optical cavity formed by a rear reflector 12, amplification module 10, and planar grating 44 remains constant to first order as the grating 44 is rotated. The grating is rotated about a pivot axis 42 formed by the intersection of the planes of the rear reflector 12 and the plane of the planar grating 44. As the grating tunes to longer wavelengths, the distance from the rear reflector to the grating increases.

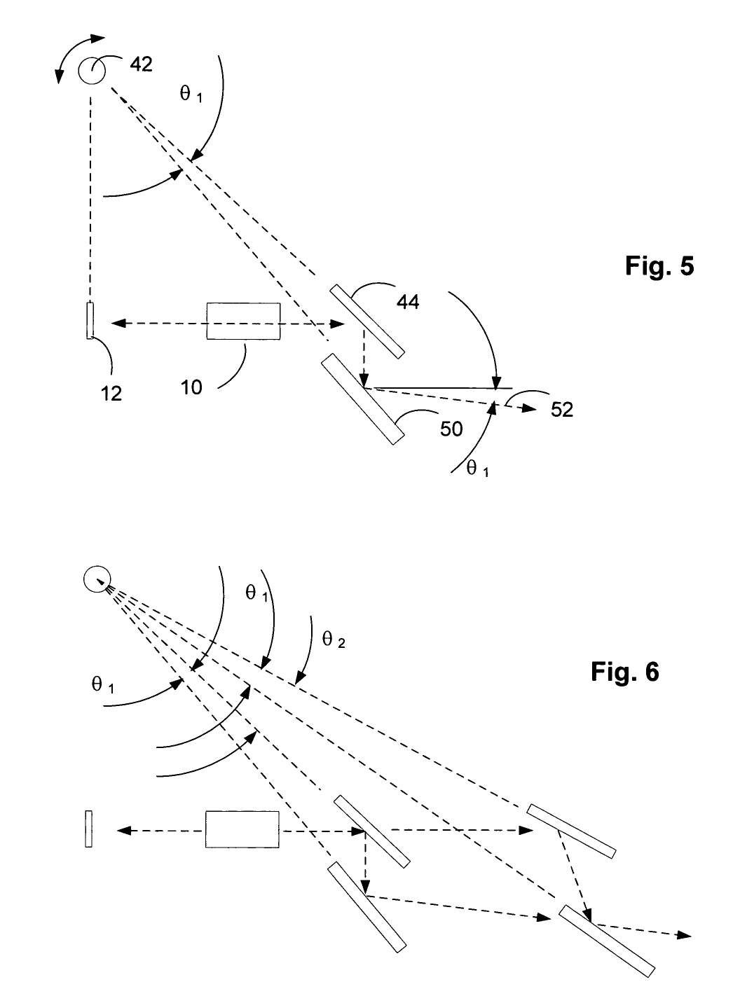

FIG. 5 shows an embodiment of the invention, where a reflector 50 is set up to rotate with the grating 44, and where the plane of the reflector 50 also intersects the plane of the grating 44 along the line of the pivot axis 42. Note that the output beam is no longer parallel to the counter propagating beams of light 16 in the amplifying module 10. However, the output beam remains parallel to itself as the grating 44 and reflector 50 are rotated, and does not move perpendicular to itself as does the output beam shown in FIG. 3 as beams 22 and 32.

FIG. 6 shows that the beam remains parallel and does not move perpendicular to itself in the (exaggerated) grating rotation θ₂ of grating 44 about axis 42.

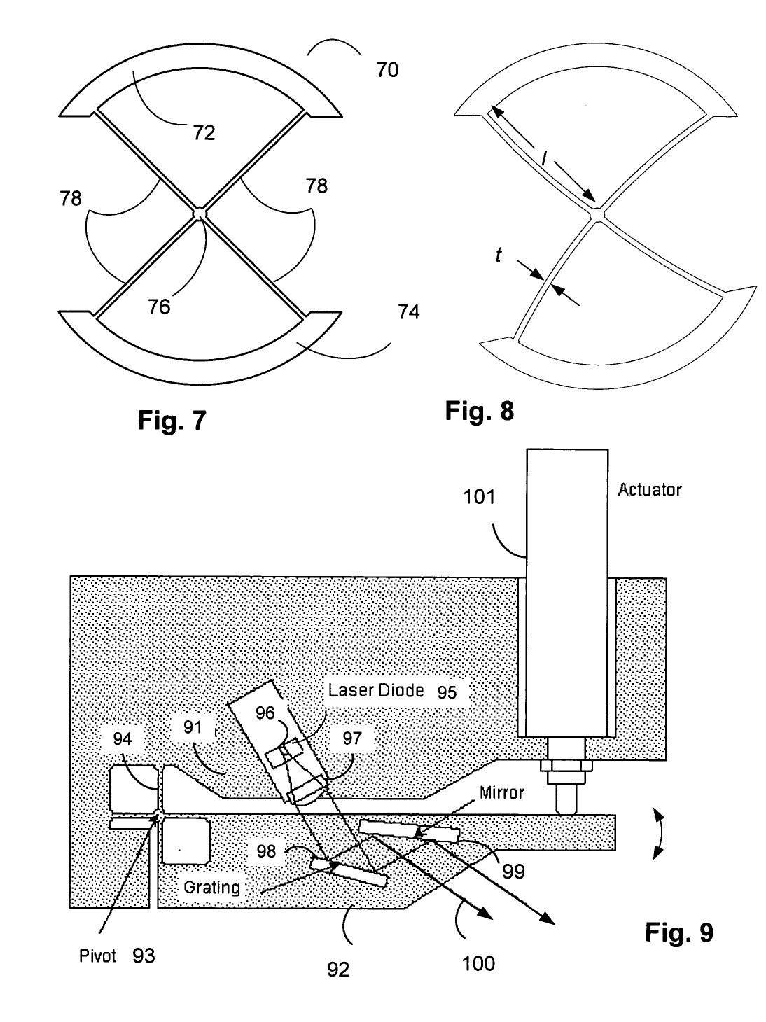

FIG. 7 shows a plan view of a flexure module 70 called a cartwheel hinge. The device as shown has two parts 72 and 74 which can rotate relative to each other about an axis 76 which is perpendicular to the plane of the paper. Thin plates 78 of length I flex as shown in FIG. 8. If the width (not shown) of the plates 78, which is the dimension of the plates out of the plane of the paper in FIGS. 7 and 8 is much larger than the thickness t of the plates, the parts 72 and 74 will have a large stiffness against any rotations about any axis perpendicular to axis 76. The pivot axis moves very little with respect to parts 72 and 74 as the parts are rotated relative to one another.

FIG. 9 shows a sketch of the most preferred embodiment of the invention. A monolithic plate of material 90 is machined, for example with an Electric Discharge Machining (EDM) device, to form a base 91 and a movable arm 92 rotatable with respect to base 91 about a pivot axis 93 formed by cartwheel hinge plates 94. Alternatively, the base 91 and movable arm 92 are joined to a single flexure element (not shown) by pressing, welding, or otherwise joining as is known in the art. Cartwheel hinges and other flexure elements are covered in section 4.3.2 (pp 199-202) of “Flexures: Elements of Elastic Mechanisms” by Stuart T. Smith, published by Gordon and Breach Science Publishers, ISBN: 90-5699-261-9.

A laser diode amplification module 95 having a highly reflecting rear facet 96 as rear reflector is mounted so that light is collimated by collimating lens and sent to grating 98. Light from the module 95 is reflected in the first diffraction order by grating 98 and returned to the module 95. Light of diffraction order zero is reflected from grating 98 to a reflector 99 and output from the device as beam 100. Since the planes of the reflector 99, the grating 98, and the rear facet 96 of the laser diode amplification module all intersect and coincide with the pivot axis 93, the laser output 100 will be tunable, and will remain parallel and not move perpendicular to itself when the movable arm 92 is rotated with respect to the fixed base 91 under the influence of actuator 101 or other movement device as is known in the art.

Obviously, many modifications and variations of the present invention are possible in light of the above teachings. It is therefore to be understood that, within the scope of the appended claims, the invention may be practiced otherwise than as specifically described.

1-13. (canceled)

14. A method, comprising:
a) mounting a tunable laser amplification module on a base, the tunable laser amplification module having a planar reflecting back reflector face and an antireflection coated output face;
b) mounting a planar diffraction grating pivotably with respect to the base, the diffraction grating for tuning a laser cavity comprising the tunable laser amplification module and the diffraction grating wherein light contained in the laser cavity propagates from the planar highly reflecting back reflector face through the antireflection coated output face to the diffraction grating, and wherein light having a diffraction order of absolute value greater than 0 is diffracted back into the laser cavity, and wherein light of diffraction order 0 is reflected out of the laser cavity,
c) mounting a planar reflecting mirror for reflecting the light of diffraction order 0 reflected out of the laser cavity, the planar reflecting mirror mounted fixedly with respect to the planar diffraction grating;
wherein the planes of the planar highly reflecting back reflector face, the planar diffraction grating, and the planar reflecting mirror intersect approximately in a line, and wherein the diffraction grating and the reflecting mirror are pivotable about the line with respect to the laser cavity reflector; and
d) pivoting the diffraction grating and the reflecting mirror with respect to the laser cavity reflector about the line.

15. An apparatus, comprising
a base;
a tunable laser amplification nodule attached to the base, the tunable laser amplification module having a planar highly reflecting back reflector face and an antireflection coated output face;
a planar diffraction grating mounted pivotably with respect to the base, the diffraction grating for tuning a laser cavity comprising the tunable laser amplification module, the diffraction grating wherein light contained in the laser cavity propagates from the planar highly reflecting back reflector face through the antireflection coated output face to the diffraction grating, and wherein light having a diffraction order of absolute value greater than 0 is diffracted back into the laser cavity, and wherein light of diffraction order 0 is reflected out of the laser cavity,
reflecting mirror for reflecting the light of diffraction order 0 reflected out of the laser cavity, the reflecting mirror mounted fixedly with respect to the planar diffraction grating;
wherein the planes of the planar highly reflecting back reflector face, the diffraction grating, and the reflecting mirror intersect in a line, and wherein the diffraction grating and the reflecting mirror are pivotable about the line with respect to the laser cavity reflector.

16. An apparatus, comprising,
a) a base;
b) a laser cavity reflector attached to the base;
c) a tunable laser amplification module attached to the base;
d) a planar diffraction grating pivotably attached to the base, the diffraction grating for tuning a laser cavity comprising the tunable laser amplification module, the diffraction grating, and the laser cavity reflector wherein light contained in the laser cavity propagates to the diffraction grating, and wherein light having a diffraction order of absolute value greater than 0 is diffracted from the grating back into the laser cavity, and wherein light of diffraction order 0 is reflected from the grating out of the laser cavity;
e) a reflecting mirror pivotably attached to the base, the reflecting mirror for reflecting the light of diffraction order 0 is reflected out of the laser cavity;
wherein the reflecting planes of the laser cavity reflector, the diffraction grating, and the reflecting mirror intersect approximately in a line, and wherein the diffraction grating and the reflecting mirror are held in a fixed relationship to each other, and wherein, the diffraction grating and the reflecting mirror are pivotable about the line with respect to the laser cavity reflector.

17. The apparatus of claim 16, further comprising a rotatable pin pivot for pivoting the diffraction grating and the reflecting mirror with respect to the base.

18. The apparatus of claim 16, further comprising a ball in socket pivot for pivoting the diffraction grating and the reflecting mirror with respect to the base.

19. The apparatus of claim 16, further comprising a flexure joint pivot for pivoting the diffraction grating and the reflecting mirror with respect to the base.

20. The apparatus of claim 19, wherein the flexure joint pivot is a cartwheel hinge pivot.

21. The apparatus of claim 16, wherein the tunable laser amplification module is a semiconductor diode, and the reflecting back reflector is a planar facet of the semiconductor diode.
